(19) United States
(12) Patent Application Publication
(10) Pub. No.: US 2006/0089174 A1
(43) Pub. Date: Apr. 27, 2006

(54) Mobile computing device with a physical button for wireless communications

(75) Inventor: Timothy D. Twerdahl, Los Altos, CA (US)

Correspondence Address: CARR & FERRELL LLP, 2200 GENG ROAD, PALO ALTO, CA, 94303, US

(73) Assignee: Tapwave, Inc.

(21) Appl. No.: 11/119,303

(22) Filed: Apr. 28, 2005

Related U.S. Application Data
(60) Provisional application No. 60/566,675, filed on Apr. 29, 2004.

(51) Int. Cl. H04B 1/38

(52) U.S. Cl. 455/567; 455/418

(57) ABSTRACT

A mobile computing device includes a wireless communication interface and a physical button for wireless communications. The wireless communication interface communicates with other devices and is switchable between a number of different wireless communications states. The physical button is used to both switch the wireless communications state of the wireless communication interface and to indicate the current wireless communications state.

### CROSS-REFERENCE TO RELATED APPLICATIONS

This application claims the benefit of U.S. Provisional Application No. 60/566,675 filed Apr. 29, 2004, titled “Mobile Computing Device with a Physical Button for Wireless Communications” which is incorporated herein by reference.

### BACKGROUND

1. Field of the Invention

The present invention relates generally to mobile computing devices, and more particularly to a mobile computing device with a physical button for wireless communications.

2. Description of the Prior Art

Many mobile devices such as personal digital assistants (PDAs), mobile phones, and laptops have the ability to use wireless communications. Some of these mobile devices use short-range wireless communications to communicate with other mobile devices in the same area. In one example, PALM PDAs from PalmOne, Inc. in Milpitas, Calif. use a Bluetooth communications standard to communicate with other devices. The Bluetooth communications in the PALM PDA are turned on and off through a software program with a “preferences” panel. One problem with this prior system is that a user of the PALM PDA may not be aware that Bluetooth communications are on, and therefore the user may be unaware that the system is consuming power and draining the battery when the user is not actively using system.

Additionally, some prior systems include a Bluetooth status indicator on the screen. A problem with these systems is that the user has no convenient way to change the state of the Bluetooth communications besides exiting a current software program and opening the “preferences” panel software program for Bluetooth communications.

Some mobile phones have an LED for indicating wireless communications. Specifically, a T68i mobile phone by Sony Ericsson has an LED for Bluetooth communications. Some laptops manufactured by Toshiba provide a toggle between Wireless Fidelity (WIFI) and Bluetooth communications using two keystrokes of a keyboard. Mobile phone headsets from Sony Ericsson have an on/off switch that turns Bluetooth communications on and off, but the switch controls the power to the entire headset. Thus, the headset cannot be on while the Bluetooth communications are inactive. One problem with these prior systems is that they do not provide a convenient and efficient solution for the user to control the wireless communications states for the mobile devices.

### SUMMARY OF THE INVENTION

The invention addresses the above problems by providing a mobile computing device with a physical button. The mobile computing device includes a wireless communication interface and a physical button for wireless communications. The wireless communication interface communicates with other devices. The physical button controls a wireless communications state of the mobile computing device.

### BRIEF DESCRIPTION OF THE DRAWINGS

FIG. 1 is a front view illustrating a mobile computing device in an exemplary implementation of the invention.

FIG. 2 is a block diagram of a computing system in the mobile computing device in an exemplary implementation of the invention.

FIG. 3 is a diagram of a state transition map for the mobile computing device in an exemplary implementation of the invention.

FIG. 4 is a diagram of a state transition map for the mobile computing device in an exemplary implementation of the invention.

### DETAILED DESCRIPTION OF THE INVENTION

The embodiments discussed herein are illustrative of one example of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

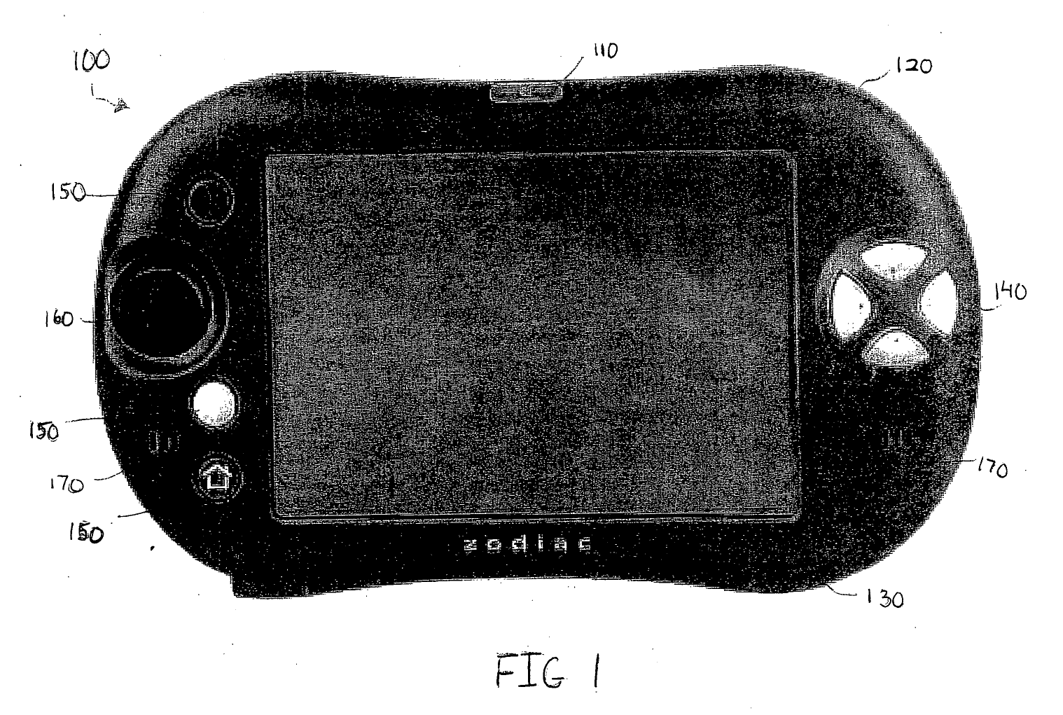

FIG. 1 is a front view illustrating a mobile computing device 100 in an exemplary implementation of the invention. In this embodiment, the mobile computing device 100 is hand-held. Other embodiments of the mobile computing device 100 are not hand-held. Examples of mobile computing devices include mobile gaming devices, personal digital assistants, and mobile phones. As shown, the mobile computing device 100 can include, without limitation, a physical button 110 for wireless communications, a housing 120, a display 130, a four-way digital input device 140, one or more digital input devices 150, an analog input device 160, and a speaker 170.

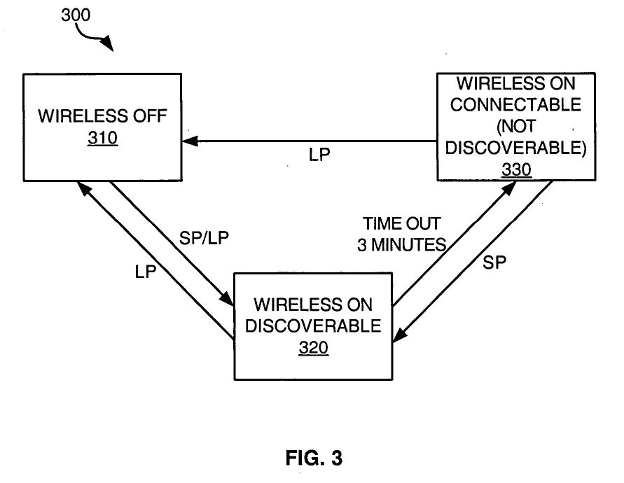

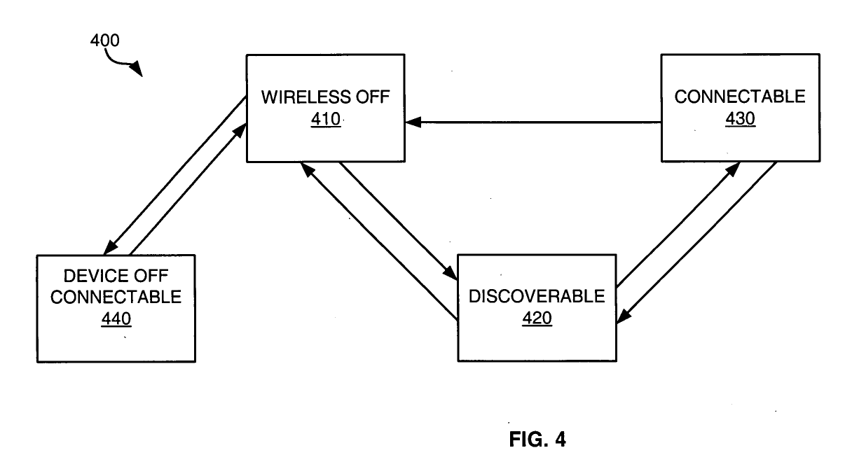

The physical button 110 is configured to change wireless communications states for the mobile computing device 100. In other embodiments, the physical button 110 can be another type of switch or toggle. In some embodiments, the physical button 110 is designed such that unintentional presses thereof are minimized. A wireless communications state is any status or condition of wireless communications for the mobile computing device 100. Examples of wireless communications states include on, off, active, inactive, discoverable, and connectable. Some examples of transitions between wireless communications states are discussed below in further detail with reference to FIGS. 3 and 4.

Although the wireless communications described herein for the mobile computing device 100 are specific for Bluetooth wireless communications, other embodiments are directed to other protocols or frequency ranges for wireless communications such as WIFI and ZigBee.

The physical button 110 can include a light indicator configured to indicate the current wireless communications state. In one embodiment, the physical button 110 includes a LED indicator (blue) in a transparent or translucent housing to allow light from the LED to readily show through. In these embodiments, the Bluetooth LED indicates that Bluetooth communications are active. In these embodiments the LED preferably produces a blue illumination to be particularly suggestive of Bluetooth communications. The light indicator not only reminds users that the wireless communications are on (implications for power, air travel, etc.), but also serves to alert others that the mobile computing device 100 has wireless communications such as Bluetooth and is ready to respond to queries from other devices. In some embodiments, the physical button 110 and the light indicator are separate components and positioned in different positions in the mobile computing device 100 rather than integrated into a single button as illustrated.

In the embodiment of FIG. 1, the physical button 110 for wireless communications is positioned at the top center of the mobile computing device 100, wrapping the radius from the top seam down to the front face so that the LED can be seen from a wide range of perspectives. There are numerous variations regarding where the physical button 110 for wireless communications can be positioned on the mobile computing device 100.

The housing 120 can be made of any type of suitable material such as plastic, metal, or hard rubber. In the embodiment shown in FIG. 1, the housing 120 is sized such that a user can comfortably hold the mobile computing device 100 during operation. The four-way digital input device 140 allows the user to input various types of information into the mobile computing device 100 by pressing any of four buttons associated with the four-way digital input device 140. The user also can input various types of information into the mobile computing device 100 by pressing on any one of the digital input devices 150. The analog input device 160 allows the user to input information into the mobile computing device 100 simply by exerting force which results in displacement of the analog input device 160 in a specific direction. The speakers 170 provide audible indicators to users of the mobile computing device 100. In one example, the speakers 170 provide audible tones to accompany transitions between wireless communications states.

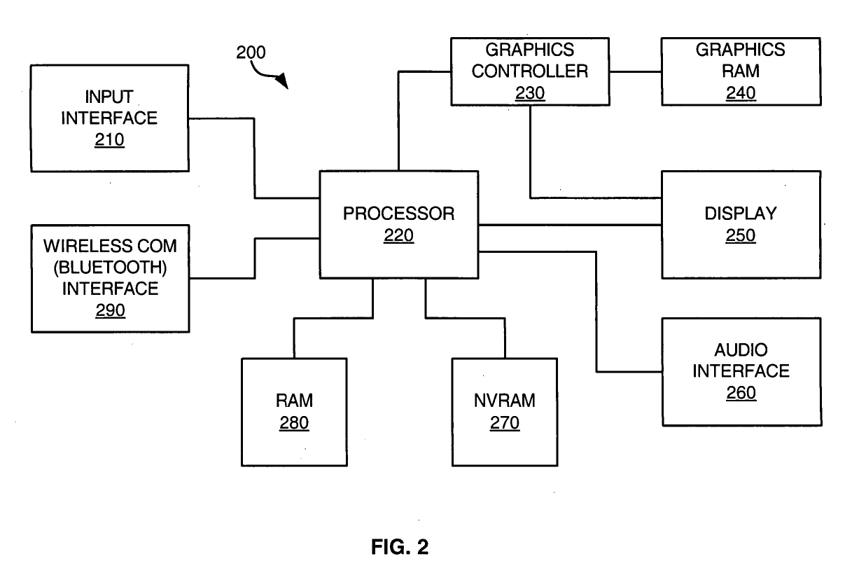

FIG. 2 depicts a block diagram of a computing system 200 of the mobile computing device 100 in an exemplary implementation of the invention. The computing system 200 includes an input interface 210, a processor 220, a graphics controller 230, a graphics random access memory (RAM) 240, a display 250, an audio interface 260, a non-volatile random access memory (NVRAM) 270, a RAM 280, and a wireless communication (Bluetooth) interface 290. Those skilled in the art will recognize this general configuration of the computing system 200 in the mobile computing device 100, and will understand that the computing system 200 in the mobile computing device 100 can be implemented in many other ways.

The input interface 210 is configured to receive user input from the physical button 110 for wireless communications, the four-way digital input device 140, one or more digital input devices 150, and/or the analog input device 160 and to transmit the user input in digital form to the processor 220. In one example, the input interface 210 exchanges information between the physical button 110 for wireless communications and the processor 220.

The processor 220 is configured to execute operating system software and application software. The processor 220 is coupled to, and communicates with, the input interface 210, the graphics controller 230, the display 250, the audio interface 260, the NVRAM 270, the RAM 280, and the wireless communication (Bluetooth) interface 290. The graphics controller 230 communicates with the graphics RAM 240 to generate graphics on the display 250. The processor 220 also communicates with the audio interface 260 to produce various sounds related to the software application(s) running on the processor 220. The RAM 280 and the NVRAM 270 are configured to store data, instructions, and/or software for the processor 220. The wireless communication interface 290 is configured to communicate with other devices using wireless communications. In this embodiment, the wireless communications is for Bluetooth communications.

FIG. 3 depicts a diagram of a state transition map 300 for the mobile computing device 100 in an exemplary implementation of the invention. FIG. 3 depicts one example including three wireless communications states and transitions between the three states. There are numerous ways to cause a transition between wireless communications states including time out periods and variations in depressing the physical button 110. For example, double pressing, analogous to double-clicking a computer mouse, can select a different transition than a single depress. Also, in some embodiments, the speakers 170 can provide an audible sound to indicate a state transition or a wireless communications state.

When the wireless communications for the mobile computing device 100 is disabled, the wireless communications state is a wireless off state 310. When a user presses the physical button 110 with either a short press (SP) or a long press (LP) in state 310, the wireless communications state transitions to a wireless on and discoverable state 320. In this discoverable state 320, the mobile computing device 100 performs discovery with other wireless devices. The mobile computing device 100 can discover or find other wireless devices that are not previously known by the mobile computing device 100. In one embodiment, a discovered wireless device is known as a trusted device where an address of the discovered wireless device is known and the mobile computing device 100 keeps a list of trusted devices. In some embodiments, the discoverable state 320 consumes more power than other states because the mobile computing device 100 is continuously trying to discover other wireless device by transmitting messages.

In some embodiments, the light indicator in the physical button 110 performs a fast flash to indicate the discoverable state 320. This fast flash can be a double flash of two flashes followed by a pause, for example. In one example, the LED indicator follows a repeating pattern of 0.2 seconds on, 0.1 off, 0.2 on, and 1.5 off. If the user presses the physical button 110 with a LP while in state 320, the state transitions back to the wireless off state 310.

In some embodiments, after a time out period such as 3 minutes, the discoverable state 320 automatically transitions to a wireless on, connectable state 330. In this connectable state 330, the mobile computing device 100 can be connected through wireless communications to another wireless device. In some embodiments, the mobile computing device 100 only connects with other wireless devices that are previously known. In one example, a wireless connection can enable two mobile computing devices 100 to play a multi-player game.

In some embodiments, the light indicator in the physical button 110 performs a slow flash in the connectable state 330. This slow flash can be a drip flash that is an infrequent flash aimed at telling the user that the wireless communications are on and connectable. One example of a drip flash is a flash of 0.5 seconds the repeats every 5 seconds. If the user presses the physical button 110 with a LP in state 330, the wireless communications state transitions back to the wireless off state 310. If the user presses the physical button 110 with a SP in state 330, the wireless communications state transitions back to the discoverable state 320.

If the mobile computing device 100 is connected to another wireless device, the light indicator in the physical button 110 can be a solid light. Also, in some embodiments, the state may transition to a connected state (not shown). In one embodiment of this connected state, the mobile computing device 100 is connected to another wireless device using an active piconet.

FIG. 4 depicts a diagram of a state transition map 400 for the mobile computing device 100 in another exemplary implementation of the invention. In FIG. 4, the wireless off state 410, the discoverable state 420, and the connectable state 430 are as described above with respect to FIG. 3. In the device off, connectable state 440, the mobile computing device 100 is powered off but still listens for other devices that might be trying to connect with the mobile computing device 100. If another device does try to connect, the mobile computing device 100 “wakes up” or turns power on. One example of this device off, connectable state 440 is when the mobile computing device 100 is off but someone else with another device wants to send a message to the mobile computing device 100.

The above-described functions can be comprised of instructions that are stored on storage media. These instructions can be retrieved and executed by a processor. Some examples of instructions are software, program code, and firmware. Some examples of storage media are memory devices, tape, disks, integrated circuits, and servers. The instructions are operational when executed by the processor to direct the processor to operate in accord with the invention. Those skilled in the art are familiar with instructions, processor, and storage media.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A mobile computing device comprising:
a wireless communication interface configured to communicate with other devices, the wireless communication interface being switchable between a plurality of different communications states; and
a physical button for switching the wireless communication interface between the wireless communications states and including a light indicator configured to indicate a current wireless communications state.
